(19) United States
(12) Patent Application Publication
(10) Pub. No.: US 2026/0131586 A1
(43) Pub. Date: May 14, 2026

(54) CONVEYING DEVICE

(71) Applicant: SEIKO EPSON CORPORATION, TOKYO (JP)

(72) Inventors: Ryo HAMANO, MATSUMOTO-SHI (JP); Yutaka HISHIDA, SHIOJIRI-SHI (JP)

(21) Appl. No.: 19/387,742

(22) Filed: Nov. 13, 2025

(30) Foreign Application Priority Data
Nov. 13, 2024 (JP) 2024-197996

(51) Int. Cl. B41J 15/16; B41J 15/04; B41J 29/00

(52) U.S. Cl. CPC B41J 15/165; B41J 15/04; B41J 29/00

(57) ABSTRACT

A conveying device includes: a medium conveying unit configured to convey a medium; a first drive unit configured to drive the medium conveying unit; a medium supply unit configured to supply the medium toward the medium conveying unit; a second drive unit configured to drive the medium supply unit; a tension bar disposed in a conveyance path between the medium conveying unit and the medium supply unit and configured to swing in a first direction and a second direction and apply tension to the conveyed medium; a third drive unit configured to swing the tension bar; a measurement unit configured to measure an output of the third drive unit when moving the tension bar; and a control unit, in which the measurement unit measures a first output of the third drive unit when moving the tension bar in the first direction and a second output of the third drive unit when moving the tension bar in the second direction, and the control unit controls the third drive unit, based on a measurement result from the measurement unit.

The present application is based on, and claims priority from JP Application Serial Number 2024-197996, filed Nov. 13, 2024, the disclosure of which is hereby incorporated by reference herein in its entirety.

### BACKGROUND

### 1. Technical Field

The present disclosure relates to a conveying device that conveys a medium.

### 2. Related Art

For example, as in JP-A-2023-22374, there is a printer which is an example of a conveying device that conveys a medium. The printer includes a medium roll support shaft which is an example of a medium supply unit, a medium roll drive mechanism which is an example of a second drive unit, a supply bar member which is an example of a tension bar, a supply bar drive mechanism which is an example of a third drive unit, and a conveying roller pair which is an example of a medium conveying unit. The printer includes a load detection sensor and a control unit.

The medium roll support shaft supports the medium roll. The medium roll drive mechanism rotates the medium roll support shaft and thus feeds the medium from the medium roll. The supply bar mechanism swings with the conveyance of the medium and thus adjusts the tension applied to the medium. The supply bar drive mechanism adjusts a driving force applied to the supply bar member. The conveying roller pair rotates in a state of sandwiching the medium and thus conveys the medium. The load detection sensor detects a load applied to the conveying roller pair.

JP-A-2023-22374 is an example of the related art.

The control unit disclosed in JP-A-2023-22374 controls the driving force of the supply bar drive mechanism, based on the load detected by the load detection sensor. The way the load is applied to the conveying roller pair also changes depending on the direction in which the supply bar member moves. However, JP-A-2023-22374 does not take into consideration the case where the load changes depending on the direction in which the supply bar member moves. Therefore, there is a problem with the stability of the conveyance of the medium.

### SUMMARY

According to an aspect of the present disclosure, a conveying device includes: a medium conveying unit configured to convey a medium; a first drive unit configured to drive the medium conveying unit; a medium supply unit configured to supply the medium toward the medium conveying unit; a second drive unit configured to drive the medium supply unit; a tension bar disposed in a conveyance path between the medium conveying unit and the medium supply unit and configured to swing in a first direction and a second direction opposite to the first direction and apply tension to the conveyed medium; a third drive unit configured to swing the tension bar; a measurement unit configured to measure an output of the third drive unit when moving the tension bar; and a control unit, in which the measurement unit measures a first output of the third drive unit when moving the tension bar in the first direction and a second output of the third drive unit when moving the tension bar in the second direction, and the control unit controls the third drive unit, based on a measurement result from the measurement unit.

### BRIEF DESCRIPTION OF THE DRAWINGS

FIG. 1 is a schematic view of an embodiment of a printing device including a conveying device.

FIG. 2 is a graph showing a first linear equation and a second linear equation.

### DESCRIPTION OF EMBODIMENTS

### Embodiment

Hereinafter, a printing device including a conveying device will be described with reference to the drawings. The printing device is, for example, an inkjet printer that performs printing by ejecting ink, which is an example of a liquid, onto a medium such as paper, fabric, or vinyl. In the drawings, assuming that a printing device 11 is placed on a horizontal plane, the direction of gravity is indicated by a Z axis and directions along the horizontal plane are indicated by an X axis and a Y axis. The X axis, the Y axis, and the Z axis are orthogonal to each other.

### Printing Device

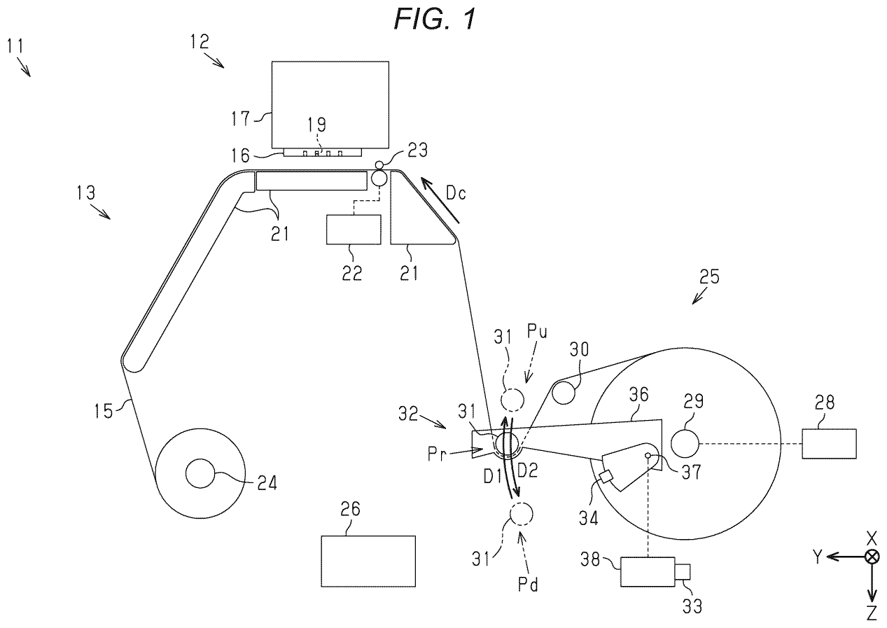

As illustrated in FIG. 1, the printing device 11 may include a printing unit 12 and a conveying device 13.

The printing unit 12 performs printing on a medium 15. The printing unit 12 may include a liquid ejection unit 16 and a carriage 17.

The liquid ejection unit 16 includes a plurality of nozzles 19. The liquid ejection unit 16 is configured to eject the liquid from the plurality of nozzles 19.

The liquid ejection unit 16 is installed in the carriage 17. The carriage 17 is configured to scan the medium 15. The liquid ejection unit 16 ejects the liquid while scanning and thus prints an image on the medium 15. The liquid ejection unit 16 performs printing on the surface of the medium 15. The liquid ejection unit 16 in the present embodiment is a serial type that scans the medium 15. The liquid ejection unit 16 may be a line type provided to be long in relation to the width of the medium 15.

### Conveying Device

The conveying device 13 is configured to convey the medium 15. The conveying device 13 may include a support unit 21, a first drive unit 22, a medium conveying unit 23, a take-up unit 24, a feeding mechanism 25, and a control unit 26.

The conveying device 13 may include a plurality of support units 21. The support unit 21 is configured to support the medium 15. The support unit 21 comes into contact with the back surface of the medium 15.

The first drive unit 22 drives the medium conveying unit 23. The first drive unit 22 is, for example, a motor.

The medium conveying unit 23 conveys the medium 15. The medium conveying unit 23 may convey the medium 15 by rotating a pair of rollers with the medium 15 interposed therebetween. The medium 15 is conveyed in a conveyance direction Dc along the support unit 21. The medium conveying unit 23 may intermittently convey the medium 15 in accordance with the timing when the printing unit 12 performs printing on the medium 15.

The take-up unit 24 winds up the printed medium 15 and thus conveys the medium 15. Specifically, the take-up unit 24 rotates the roll-shaped medium 15 in the counterclockwise direction in FIG. 1 and thus draws up the medium 15.

### Feeding Mechanism

The feeding mechanism 25 may include a second drive unit 28, a medium supply unit 29, a driven roller 30, a tension bar 31, and a swing unit 32. The feeding mechanism 25 may include a measurement unit 33 and a detection unit 34.

The second drive unit 28 drives the medium supply unit 29. The second drive unit 28 is, for example, a motor.

The medium supply unit 29 supplies the medium 15 toward the medium conveying unit 23. The medium supply unit 29 feeds the long medium 15. The medium supply unit 29 supports the medium 15 before printing that is wound in a roll shape, in a rotatable manner. The medium supply unit 29 conveys the medium 15 by rotating. Specifically, the medium supply unit 29 rotates the roll-shaped medium 15 in the counterclockwise direction in FIG. 1 and thus feeds the medium 15. The fed medium 15 is wound around the driven roller 30, the tension bar 31, and the medium conveying unit 23 in this order.

The driven roller 30 may rotate, following the conveyed medium 15. The driven roller 30 may slide in relation to the medium 15. The driven roller 30 may come into contact with the back surface of the medium 15.

The tension bar 31 is disposed in a conveyance path between the medium conveying unit 23 and the medium supply unit 29. The tension bar 31 swings in a first direction D1 and a second direction D2. The second direction D2 is a direction opposite to the first direction D1. The first direction D1 in the present embodiment is an upward direction. The second direction D2 in the present embodiment is a downward direction. The tension bar 31 may be rotationally movable in both directions between a lower position Pd and an upper position Pu indicated by two-dot chain lines in FIG. 1. The rotational movement refers to a rotation about an axis in which the available angle of rotation is less than 360 degrees. The tension bar 31 may be in contact with the surface of the medium 15. The tension bar 31 applies tension to the conveyed medium 15.

The swing unit 32 may include an arm part 36, a rotational movement shaft 37, and a third drive unit 38.

The swing unit 32 may include a pair of arm parts 36. The pair of arm parts 36 may support the two ends of the tension bar 31. The arm part 36 supports the tension bar 31. The arm part 36 may support the tension bar 31 at the distal end. The arm part 36 may be fixed to the rotational movement shaft 37. The arm part 36 is rotationally movable about the rotational movement shaft 37. The arm part 36 displaces the tension bar 31 by rotationally moving.

The rotational movement shaft 37 may rotationally move the arm part 36. The rotational movement shaft 37 may be divided. The rotational movement shaft 37 of one arm part 36 and the rotational movement shaft 37 of the other arm part 36 may be integrated together, or a pair of rotational movement shafts 37 may be provided coaxially. The rotational movement shaft 37 may move the tension bar 31 in the first direction D1 by rotating forward. The rotational movement shaft 37 may move the tension bar 31 in the second direction D2 by rotating in the reverse direction.

The third drive unit 38 swings the tension bar 31. Specifically, the third drive unit 38 drives the rotational movement shaft 37. The third drive unit 38 rotationally moves the rotational movement shaft 37 and the arm part 36 and thus swings the tension bar 31. The third drive unit 38 is, for example, a motor.

The measurement unit 33 measures the output of the third drive unit 38 when the tension bar 31 is moved. For example, the measurement unit 33 may measure the current value when the third drive unit 38 is driven. The measurement unit 33 may measure, for example, the voltage value when the third drive unit 38 is driven.

The detection unit 34 may detect the speed at which the tension bar 31 moves, the direction in which the tension bar 31 moves, and the position of the tension bar 31. The detection unit 34 may directly or indirectly detect the speed, direction, and position of the tension bar 31.

The detection unit 34 in the present embodiment is a rotary encoder. The scale of the rotary encoder may be provided on the rotational movement shaft 37. The control unit 26 may calculate the movement speed, direction, and position of the tension bar 31, based on the rotation speed and direction of rotation of the rotational movement shaft 37.

Specifically, the detection unit 34 may output A-phase and B-phase pulse signals having phases different from each other. The phases of the two types of pulse signals may be different by, for example, 90 degrees. For example, when the rotational movement shaft 37 rotates forward, the A-phase precedes the B-phase. When the rotational movement shaft 37 rotates in the reverse direction, the B-phase precedes the A-phase. Therefore, the control unit 26 may determine the direction of rotation of the rotational movement shaft 37, based on whether the A-phase precedes or lags behind the B-phase. The control unit 26 may calculate the rotation speed of the rotational movement shaft 37, based on the number of pulses per unit time. For example, the control unit 26 may calculate the position of the tension bar 31 from the amount of rotation and the direction of rotation of the rotational movement shaft 37, based on the lower position Pd as a reference point.

The control unit 26 performs overall control on the driving of each mechanism in the conveying device 13 and controls various operations executed by the conveying device 13. The control unit 26 may control the driving and various operations of each mechanism in the printing device 11.

The control unit 26 can be configured as a circuit including a: one or more processors that execute various kinds of processing in accordance with a computer program, B: one or more dedicated hardware circuits that execute at least a part of the various kinds of processing, or y: a combination of a and B. The hardware circuit is, for example, an application-specific integrated circuit. The processor includes a CPU and a memory such as a RAM and a ROM, and the memory stores program codes or commands configured to cause the CPU to execute processing. The memory, that is, a computer-readable medium includes any readable medium that can be accessed by a general-purpose or dedicated computer.

### Measurement Operation

The control unit 26 executes the measurement operation before performing printing on the medium 15. The measurement operation may be executed by the manufacturer before the shipment of the printing device 11. The measurement operation may be executed by the user before printing. The measurement operation is performed in a state where the medium 15 is not wound around the tension bar 31. That is, the tension bar 31 during the measurement operation is not in contact with the medium 15.

When the measurement operation is started, the control unit 26 positions the tension bar 31 at the lower position Pd. The control unit 26 may position the tension bar 31 at the lower position Pd by driving the third drive unit 38 in the reverse direction for a predetermined period of time. Subsequently, the control unit 26 may drive the third drive unit 38 to move the tension bar 31 forward and backward twice. The measurement unit 33 measures a first output of the third drive unit 38 when the tension bar 31 is moved in the first direction D1 and a second output of the third drive unit 38 when the tension bar 31 is moved in the second direction D2.

Specifically, the control unit 26 drives the third drive unit 38 forward at a high speed and causes the measurement unit 33 to measure the output of the third drive unit 38. That is, the control unit 26 moves the tension bar 31 in the first direction D1 at a first speed V1. The measurement result from the measurement unit 33 at this time is defined as a first high-speed output TiH1. The first high-speed output TiH1 is an example of the first output. In other words, the first high-speed output TiH1 is the first output of the third drive unit 38 when the tension bar 31 is moved in the first direction D1 at the first speed V1. The control unit 26 may move the tension bar 31 to the upper position Pu. The first high-speed output TiH1 may be the average value from when the driving of the third drive unit 38 is started to when the driving is stopped.

Subsequently, the control unit 26 drives the third drive unit 38 in the reverse direction at a high speed and causes the measurement unit 33 to measure the output of the third drive unit 38. That is, the control unit 26 moves the tension bar 31 in the second direction D2 at a third speed V3. The measurement result from the measurement unit 33 at this time is defined as a second high-speed output TiH2. The second high-speed output TiH2 is an example of the second output. In other words, the second high-speed output TiH2 is the second output of the third drive unit 38 when the tension bar 31 is moved in the second direction D2 at the third speed V3. The control unit 26 may move the tension bar 31 to the lower position Pd. The second high-speed output TiH2 may be the average value from when the driving of the third drive unit 38 is started to when the driving is stopped.

Next, the control unit 26 drives the third drive unit 38 forward at a low speed and causes the measurement unit 33 to measure the output of the third drive unit 38. That is, the control unit 26 moves the tension bar 31 in the first direction D1 at a second speed V2. The measurement result from the measurement unit 33 at this time is defined as a first low-speed output TiL1. The second speed V2 is lower than the first speed V1. The first low-speed output Till is an example of the first output. In other words, the first low-speed output Till is the first output of the third drive unit 38 when the tension bar 31 is moved in the first direction D1 at the second speed V2. The first output may include the first high-speed output TiH1 and the first low-speed output Till. The control unit 26 may move the tension bar 31 to the upper position Pu. The first low-speed output Till may be the average value from when the driving of the third drive unit 38 is started to when the driving is stopped.

The control unit 26 drives the third drive unit 38 in the reverse direction at a low speed and causes the measurement unit 33 to measure the output of the third drive unit 38. That is, the control unit 26 moves the tension bar 31 in the second direction D2 at a fourth speed V4. The measurement result from the measurement unit 33 at this time is defined as a second low-speed output TiL2. The fourth speed V4 is lower than the third speed V3. The second low-speed output TiL2 is an example of the second output. In other words, the second low-speed output TiL2 is the second output of the third drive unit 38 when the tension bar 31 is moved in the second direction D2 at the fourth speed V4. The second output may include the second high-speed output TiH2 and the second low-speed output TiL2. The control unit 26 may move the tension bar 31 to the lower position Pd. The second low-speed output TiL2 may be the average value from when the driving of the third drive unit 38 is started to when the driving is stopped.

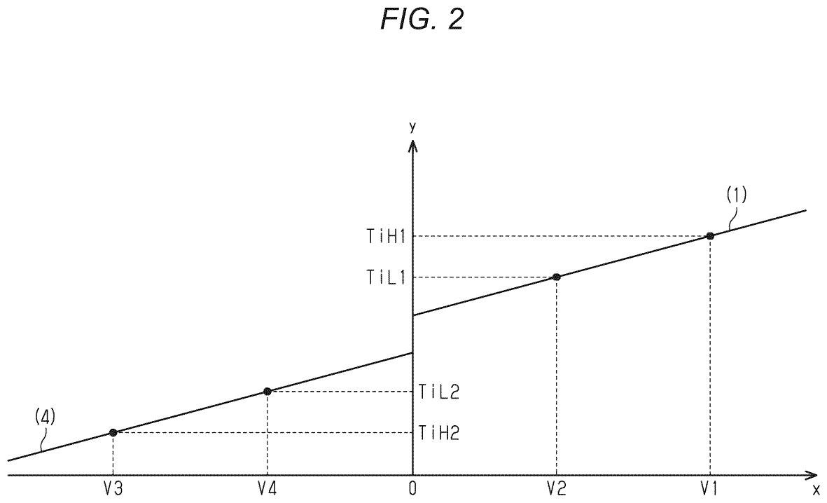

As illustrated in FIG. 2, the control unit 26 formulates Equation (1), which is an example of the first linear equation, based on the measurement result from the measurement unit 33. In the graph of FIG. 2, a line represented by Equation (1) is shown, assuming that the speed of movement in the first direction D1 is positive. The first linear equation is based on the first speed V1, the second speed V2, the first high-speed output TiH1, and the first low-speed output Till. Specifically, the control unit 26 finds a coefficient a based on Equation (2). The control unit 26 finds a coefficient b based on Equation (3). The control unit 26 reflects the coefficient a and the coefficient b in Equation (1).

$$y = ax + b \qquad ( 1 )$$

$$a = \frac{TiH 1 - TiL 1}{V 1 - V 2} \qquad ( 2 )$$

$$b = TiH 1 - \frac{( TiH 1 - TiL 1 ) \times V 1}{V 1 - V 2} \qquad ( 3 )$$

The control unit 26 formulates Equation (4), which is an example of the second linear equation, based on the measurement result from the measurement unit 33. In the graph of FIG. 2, a line represented by Equation (4) is shown, assuming that the speed of movement in the second direction D2 is negative. The second linear equation is based on the third speed V3, the fourth speed V4, the second high-speed output TiH2, and the second low-speed output TiL2. Specifically, the control unit 26 finds a coefficient a′ based on Equation (5). The control unit 26 finds a coefficient b′ based on Equation (6). The control unit 26 reflects the coefficient a′ and the coefficient b′ in Equation (4).

$$y = a ’ x + b ’ \qquad ( 4 )$$

$$a ’ = \frac{TiH 2 - TiL 2}{V 3 - V 4} \qquad ( 5 )$$

$$b ’ = TiH 2 - \frac{( TiH 2 - TiL 2 ) \times V 3}{V 3 - V 4} \qquad ( 6 )$$

### Conveyance Operation

As illustrated in FIG. 1, the conveying device 13 conveys the medium 15 from the feeding mechanism 25 to the take-up unit 24. When the medium conveying unit 23 conveys the medium 15, the tension applied to the medium 15 upstream of the medium conveying unit 23 in the conveyance direction Dc increases. Therefore, the medium 15 pushes up the tension bar 31. That is, the tension bar 31 moves in the first direction D1.

The detection unit 34 detects the movement speed, direction, and position of the tension bar 31.

The control unit 26 drives the second drive unit 28 according to the position of the tension bar 31. When the tension bar 31 is located on the first direction D1 side of a reference position Pr indicated by a solid line in FIG. 1, the control unit 26 may rotate the medium supply unit 29 in the counterclockwise direction in FIG. 1. That is, when the tension bar 31 is located above the reference position Pr, the medium 15 is supplied from the medium supply unit 29. Therefore, the tension bar 31 moves downward due to its own weight. The tension bar 31 moves in the second direction D2.

When the tension bar 31 is located on the second direction D2 side of the reference position Pr, the control unit 26 may rotate the medium supply unit 29 in the clockwise direction in FIG. 1. That is, when the tension bar 31 is located below the reference position Pr, the medium supply unit 29 winds up the medium 15. Therefore, the tension bar 31 moves in the first direction D1.

### Assistance Operation

The control unit 26 executes an assistance operation in parallel with the conveyance operation. When the detector 34 detects the movement of the tension bar 31, the control unit 26 executes the assistance operation.

When the tension bar 31 moves in the first direction D1, the control unit 26 controls the third drive unit 38, using Equation (1), which is the first linear equation. The control unit 26 substitutes the speed detected by the detection unit 34 for x in the first linear equation and thus finds y. This y is the output of the third drive unit 38 required to move the tension bar 31 in the first direction D1 at the speed detected by the detection unit 34. The control unit 26 drives the third drive unit 38 with an output found by subtracting the tension necessary for conveying the medium 15 from the calculated y.

When the tension bar 31 moves in the second direction D2, the control unit 26 controls the third drive unit 38, using Equation (4), which is the second linear equation. The control unit 26 substitutes the speed detected by the detection unit 34 for x in the second linear equation and thus finds y. This y is the output of the third drive unit 38 required to move the tension bar 31 in the second direction D2 at the speed detected by the detection unit 34. The control unit 26 drives the third drive unit 38 with an output found by subtracting the tension necessary for conveying the medium 15 from the calculated y.

### Functions of Present Embodiment

The functions of the present embodiment will be described.

The control unit 26 controls the third drive unit 38, based on the measurement result from the measurement unit 33. When the conveyed medium 15 moves the tension bar 31 in the first direction D1, the control unit 26 causes the third drive unit 38 to assist the movement of the tension bar 31, based on the first linear equation and the movement speed of the tension bar 31. When the conveyed medium 15 moves the tension bar 31 in the second direction D2, the control unit 26 causes the third drive unit 38 to assist the movement of the tension bar 31, based on the second linear equation and the movement speed of the tension bar 31.

### Effects of the Present Embodiment

The effects of the present embodiment will be described.
(1-1) The control unit 26 controls the third drive unit 38, based on the first output when the tension bar 31 is moved in the first direction D1 and the second output when the tension bar 31 is moved in the second direction D2. Thus, since the third drive unit 38 is controlled in consideration of the direction in which the tension bar 31 moves, the medium 15 can be stably conveyed.
(1-2) The load for moving the tension bar 31 changes according to the movement speed in addition to the direction of movement. In this regard, the measurement unit 33 performs measurement while changing the speed at which the tension bar 31 is moved. Thus, the reliability of the first linear equation and the second linear equation can be enhanced.
(1-3) When the tension bar 31 moves in the first direction D1, the control unit 26 controls the third drive unit 38 according to the first linear equation and the speed at which the tension bar 31 moves. When the tension bar 31 moves in the second direction D2, the control unit 26 controls the third drive unit 38 according to the second linear equation and the speed at which the tension bar 31 moves. That is, the control unit 26 causes the third drive unit 38 to assist the movement of the tension bar 31 according to the direction in which and the speed at which the tension bar 31 moves. Thus, the medium 15 can be conveyed more stably.
(1-4) The arm part 36 supports the tension bar 31. The arm part 36 rotationally moves with the rotational movement of the rotational movement shaft 37. Thus, the tension bar 31 can be easily swung by causing the third drive unit 38 to drive the rotational movement shaft 37.
(1-5) Gravity acts on the tension bar 31. Therefore, for example, when the tension bar 31 is swung in the vertical direction, the difference between the load when moving in the first direction D1 and the load when moving in the second direction D2 tends to be larger than when the tension bar 31 is swung in the horizontal direction. In this regard, the control unit 26 drives the third drive unit 38 in consideration of the direction in which the tension bar 31 is moved. Therefore, even when the tension bar 31 is swung upward and downward, the movement of the tension bar 31 can be appropriately assisted.
(1-6) The load for rotating the medium supply unit 29 changes depending on the amount of the medium 15 supported by the medium supply unit 29. The medium 15 wound in a roll shape is also referred to as a roll body. For example, a roll body having a large diameter takes more time to start or stop moving than a roll body having a small diameter. When a large roll body is used, it is difficult to feed the medium 15 with an appropriate tension. In this regard, the medium conveying unit 23 includes the tension bar 31 provided between the medium supply unit 29 and the medium conveying unit 23. Therefore, the tension applied to the medium 15 can be quickly adjusted.
(1-7) The output of the third drive unit 38 when the tension bar 31 is moved may change, for example, depending on the period in which the conveying device 13 is used or the environment in which the conveying device 13 is used. In this regard, the conveying device 13 includes the measurement unit 33. As the measurement unit 33 is made to measure the first output and the second output before the medium 15 is conveyed, the third drive unit 38 can be controlled more accurately.

### MODIFICATION EXAMPLES

The present embodiment can be implemented with the modifications described below. The present embodiment and the modification examples given below can be implemented in combination with each other as long as no technical inconsistencies are involved.

The detection unit 34 may separately include a speed detection unit that detects the speed at which the tension bar 31 moves, a direction detection unit that detects the direction in which the tension bar 31 moves, and a position detection unit that detects the position of the tension bar 31.

The tension bar 31 may be located in the conveyance path between the medium conveying unit 23 and the take-up unit 24. The tension bar 31 may apply tension to the printed medium 15. The swing unit 32 may assist the movement of the tension bar 31 located downstream of the printing unit 12.

The control unit 26 may acquire a measurement result of measurement by the measurement unit 33 provided in another device than the conveying device 13 and formulate the first linear equation and the second linear equation. The first linear equation and the second linear equation may be formulated by another device than the conveying device 13. The control unit 26 may acquire the first linear equation and the second linear equation formulated by another device.

The tension bar 31 may move linearly forward and backward. The first direction D1 and the second direction D2 may be directions along a horizontal plane. The first direction D1 may be a vertical direction perpendicular to the horizontal plane or a direction obliquely intersecting the horizontal plane.

In the measurement operation, the control unit 26 may cause the tension bar 31 to move forward and backward once. The control unit 26 may change the speed of the tension bar 31 moving in the first direction D1 or the second direction D2 during the movement. For example, the control unit 26 may move the tension bar 31 from the lower position Pd to the reference position Pr at the second speed V2 and move the tension bar 31 from the reference position Pr to the upper position Pu at the first speed V1. The control unit 26 may move the tension bar 31 from the upper position Pu to the reference position Pr at the fourth speed V4 and move the tension bar 31 from the reference position Pr to the lower position Pd at the third speed V3.

In the measurement operation, the control unit 26 may cause the tension bar 31 to move forward and backward three times or more, while changing the speed of the tension bar 31. The control unit 26 may formulate an equation for assisting the tension bar 31 moving in the first direction D1, from three or more combinations of the speed and the first output. The control unit 26 may formulate an equation for assisting the tension bar 31 moving in the second direction D2, from three or more combinations of the speed and the second output.

The conveying device 13 may be provided in a device different from the printing device 11. The conveying device 13 may not include the take-up unit 24. The conveying device 13 may supply the medium 15 to another device. For example, the conveying device 13 may supply the medium 15 to a cutting device that cuts the medium 15.

The printing device 11 is not limited to the inkjet printer and may be a laser printer, a thermal printer, a dot impact printer, a digital printing machine, or the like.

The printing device 11 is a device that prints images such as text, pictures, or photos by causing a liquid such as ink or a fluid such as a toner to adhere to the medium 15, and may be a serial printer, a lateral-type printer, a line printer, a page printer or the like. The printing device 11 may be an offset printing device, a textile printing device, or the like.

### Definition

The expression “at least one” used in this specification means “one or more” of desired alternatives. For example, when the number of alternatives is two, the expression “at least one” used in the present specification means “only one alternative” or “both of the two alternatives”. As another example, when the number of alternatives is three or more, the expression “at least one” used in the present specification means “only one alternative”, “a combination of any two alternatives”, or “a combination of any three or more alternatives”.

### APPENDICES

Technical ideas understood from the above-described embodiment and modification examples, and the functions and effects thereof, will be described below.
[1] A conveying device includes: a medium conveying unit configured to convey a medium; a first drive unit configured to drive the medium conveying unit; a medium supply unit configured to supply the medium toward the medium conveying unit; a second drive unit configured to drive the medium supply unit; a tension bar disposed in a conveyance path between the medium conveying unit and the medium supply unit and configured to swing in a first direction and a second direction opposite to the first direction and apply tension to the conveyed medium; a third drive unit configured to swing the tension bar; a measurement unit configured to measure an output of the third drive unit when moving the tension bar; and a control unit, in which the measurement unit measures a first output of the third drive unit when moving the tension bar in the first direction and a second output of the third drive unit when moving the tension bar in the second direction, and the control unit controls the third drive unit, based on a measurement result from the measurement unit.

With this configuration, the control unit controls the third drive unit based on the first output when the tension bar is moved in the first direction and the second output when the tension bar is moved in the second direction. Thus, since the third drive unit is controlled in consideration of the direction in which the tension bar moves, the medium can be stably conveyed.
[2] In the conveying device according to the above-described [1], the first output may include a first high-speed output when the tension bar is moved in the first direction at a first speed and a first low-speed output when the tension bar is moved in the first direction at a second speed lower than the first speed, the second output may include a second high-speed output when the tension bar is moved in the second direction at a third speed and a second low-speed output when the tension bar is moved in the second direction at a fourth speed lower than the third speed, and the control unit may control the third drive unit, using a first linear equation based on the first speed, the second speed, the first high-speed output, and the first low-speed output, and a second linear equation based on the third speed, the fourth speed, the second high-speed output, and the second low-speed output.

The load for moving the tension bar changes according to the movement speed in addition to the direction of movement. In this regard, with this configuration, the measurement unit performs measurement while changing the speed at which the tension bar is moved. Thus, the reliability of the first linear equation and the second linear equation can be enhanced.
[3] In the conveying device according to the above-described [2], the control unit may cause the third drive unit to assist a movement of the tension bar, based on the first linear equation and a speed at which the tension bar moves when the conveyed medium moves the tension bar in the first direction, and may cause the third drive unit to assist a movement of the tension bar, based on the second linear equation and a speed at which the tension bar moves when the conveyed medium moves the tension bar in the second direction.

With this configuration, when the tension bar moves in the first direction, the control unit controls the third drive unit according to the first linear equation and the speed at which the tension bar moves. When the tension bar moves in the second direction, the control unit controls the third drive unit according to the second linear equation and the speed at which the tension bar moves. That is, the control unit causes the third drive unit to assist the movement of the tension bar according to the direction in which and the speed at which the tension bar moves. Thus, the medium can be conveyed more stably.
[4] The conveying device according to any one of the above-described [1] to [3] may further include an arm part that supports the tension bar, and a rotational movement shaft that rotationally moves the arm part, and the third drive unit may drive the rotational movement shaft.

With this configuration, the arm part supports the tension bar. The arm part rotationally moves with the rotational movement of the rotational movement shaft. Thus, the tension bar can be easily swung by causing the third drive unit to drive the rotational movement shaft.
[5] In the conveying device according to any one of above-described [1] to [4], the first direction may be an upward direction, and the second direction may be a downward direction.

Gravity acts on the tension bar. Therefore, for example, when the tension bar is swung in the vertical direction, the difference between the load when moving in the first direction and the load when moving in the second direction tends to be larger than when the tension bar is swung in the horizontal direction. In this regard, with this configuration, the control unit drives the third drive unit in consideration of the direction in which the tension bar is moved. Therefore, even when the tension bar is swung upward and downward, the movement of the tension bar can be appropriately assisted.

What is claimed is:

1. A conveying device comprising:
a medium conveying unit configured to convey a medium;
a first drive unit configured to drive the medium conveying unit;
a medium supply unit configured to supply the medium toward the medium conveying unit;
a second drive unit configured to drive the medium supply unit;
a tension bar disposed in a conveyance path between the medium conveying unit and the medium supply unit and configured to swing in a first direction and a second direction opposite to the first direction and apply tension to the conveyed medium;
a third drive unit configured to swing the tension bar;
a measurement unit configured to measure an output of the third drive unit when moving the tension bar; and
a control unit, wherein
the measurement unit measures
a first output of the third drive unit when moving the tension bar in the first direction, and
a second output of the third drive unit when moving the tension bar in the second direction, and
the control unit controls the third drive unit, based on a measurement result from the measurement unit.

2. The conveying device according to claim 1, wherein
the first output includes
a first high-speed output when the tension bar is moved in the first direction at a first speed, and
a first low-speed output when the tension bar is moved in the first direction at a second speed lower than the first speed,
the second output includes
a second high-speed output when the tension bar is moved in the second direction at a third speed, and
a second low-speed output when the tension bar is moved in the second direction at a fourth speed lower than the third speed, and
the control unit controls the third drive unit, using
a first linear equation based on the first speed, the second speed, the first high-speed output, and the first low-speed output, and
a second linear equation based on the third speed, the fourth speed, the second high-speed output, and the second low-speed output.

3. The conveying device according to claim 2, wherein
the control unit
causes the third drive unit to assist a movement of the tension bar, based on the first linear equation and a speed at which the tension bar moves when the conveyed medium moves the tension bar in the first direction, and
causes the third drive unit to assist a movement of the tension bar, based on the second linear equation and a speed at which the tension bar moves when the conveyed medium moves the tension bar in the second direction.

4. The conveying device according to claim 1, further comprising:
an arm part configured to support the tension bar; and
a rotational movement shaft configured to rotationally move the arm part, wherein
the third drive unit drives the rotational movement shaft.

5. The conveying device according to claim 1, wherein
the first direction is an upward direction, and the second direction is a downward direction.
